(19) United States
(12) Patent Application Publication
(10) Pub. No.: US 2017/0111254 A1
(43) Pub. Date: Apr. 20, 2017

(54) DEVICE, COMMUNICATION SYSTEM, AND METHOD USING A COMMUNICATION SYSTEM

(71) Applicant: FUJITSU LIMITED, Kawasaki-shi (JP)

(72) Inventors: NAOYOSHI OHKAWA, Kawasaki (JP); Yuji NOMURA, Kawasaki (JP); SUMIYO OKADA, Kawasaki (JP); Fumiyuki Iizuka, Kawasaki (JP)

(73) Assignee: FUJITSU LIMITED, Kawasaki-shi (JP)

(21) Appl. No.: 15/279,911

(22) Filed: Sep. 29, 2016

(30) Foreign Application Priority Data
Oct. 20, 2015 (JP) 2015-206744

(51) Int. Cl. H04L 12/26

(52) U.S. Cl. CPC H04L 43/0888; H04L 43/0864; H04L 69/16

(57) ABSTRACT

A device is configured to specify a first time difference between a first time in which a first data packet is transmitted and a second time in which a first response packet is received, specify a second time difference between the second time and a third time in which a second response packet is received, the second response packet being a final response packet corresponding to second data packets transmitted after the first time and before the second time, specify a first data amount of the one or more second data packets, and a second data amount of the first data packet and the one or more second data packets, specify a first throughput value based on the second data amount and the first time difference, specify a second throughput value based on the first data amount and the second time difference.

### CROSS-REFERENCE TO RELATED APPLICATION

This application is based upon and claims the benefit of priority of the prior Japanese Patent Application No. 2015-206744, filed on Oct. 20, 2015, the entire contents of which are incorporated herein by reference.

### FIELD

The embodiment discussed herein is related to a device, a communication system, and a method using a communication system.

### BACKGROUND

A technology is disclosed in which TCP protocol packets are acquired and a throughput between devices is calculated. For example, an information processing device extracts a data transmission and reception execution period excluding a non-data transmission and reception execution period which occurs in a communication connection setting period between a server and a client, and calculates a maximum throughput based on time corresponding to the data transmission and reception execution period and the amount of transmitted data. The data transmission and reception execution period is a period from the start of consecutive data transmission based on a window size to the reception of reception acknowledgement (ack) corresponding to the transmitted consecutive data. Japanese Laid-open Patent Publication No. 2006-279283, Japanese Laid-open Patent Publication No. 2007-243308, and Japanese Laid-open Patent Publication No. 2011-259307 are examples of the related art.

### SUMMARY

According to an aspect of the invention, a device includes a memory, and a processor coupled to the memory and configured to specify a first time difference between a first time in which a first data packet is transmitted by a transmitter toward a receiver and a second time in which a first response packet corresponding to the first data packet is received by the transmitter, specify a second time difference between the second time and a third time in which a second response packet is received by the transmitter, the second response packet being a final response packet corresponding to one or more second data packets transmitted by the transmitter toward the receiver after the first time and before the second time, specify a first data amount which is a total data amount of the one or more second data packets, and a second data amount which is a total data amount of the first data packet and the one or more second data packets, specify a first throughput value based on the second data amount and the first time difference, specify a second throughput value based on the first data amount and the second time difference, and output the first throughput value when the first throughput value is equal to or smaller than the second throughput value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating functional configuration of a packet analysis device according to an embodiment;

FIGS. 2A and 2B are diagrams illustrating problems of TCP throughput estimation;

FIG. 3 is a diagram illustrating a process performed by a throughput estimation unit according to the embodiment;

FIGS. 4A, 4B, 4C, and 4D are diagrams illustrating the process performed by the throughput estimation unit according to the embodiment in detail;

FIG. 5 is a table illustrating an example of a data structure of an analysis information table;

FIG. 6 is a table illustrating an example of a data structure of a DATA table;

FIG. 7 is a table illustrating an example of a data structure of an ACK table;

FIG. 8 is a table illustrating an example of a data structure of a statistical information table;

FIG. 9A is a flowchart illustrating a process performed in a case of connection establishment according to the embodiment;

FIG. 9B is a flowchart illustrating a process performed in a case of data packet reception;

FIG. 9C is a flowchart illustrating a process performed in a case of ACK packet reception;

FIG. 10 is a diagram illustrating a detailed example of a process performed by a packet analysis device according to the embodiment;

FIG. 11 is a diagram illustrating an output example; and

FIG. 12 is a diagram illustrating an example of a computer which performs a packet analysis program.

### DESCRIPTION OF EMBODIMENT

A method of calculating throughput between devices according to the related art has a problem in which it is difficult to measure accurate throughput between the devices. In a case in which there is a band gap between a transmission side and a reception side, for example, in a case in which a band of the reception side is narrower than that of the transmission side, it is difficult to accurately measure the throughput between the devices. Here, the problem in which it is difficult to accurately measure the throughput between the devices will be described.

In the related art, there is a large number of cases in which a path between devices is a wired network and there is a small number of cases in which a band gap exists between the transmission side and the reception side, with the result that there is a small number of cases in which the band of the reception side is narrower than that of the transmission side, and thus there is a small number of cases in which the accuracy of estimation of the throughput between the devices causes a problem. That is, it is possible for an information processing device to accurately measure the throughput between the devices based on time of data transmission and reception execution period and the amount of transmitted data.

In contrast, in recent years, smart phones and wireless networks, such as Wi-Fi®, which is slow and unstable, have been spread, with the result that a section in which the band of the reception side is narrower than that of the transmission side increases, and thus there is a case in which estimation accuracy causes a problem in the calculation method according to the related art. That is, in the case in which the band of the reception side is narrower than that of the transmission side increases, the information processing device is affected in the section in which the band is narrow even though the throughput between the devices are measured based on time of the data transmission and reception execution period and the amount of the transmission data, and thus it is difficult to accuracy measure the throughput between the devices.

Hereinafter, an embodiment of a packet analysis program, a packet analyze device, and a packet analysis method disclosed in the specification will be described in detail with reference to the accompanying drawing. Meanwhile, the embodiment does not limit the disclosure.

[Configuration of Packet Analysis Device According to Embodiment]

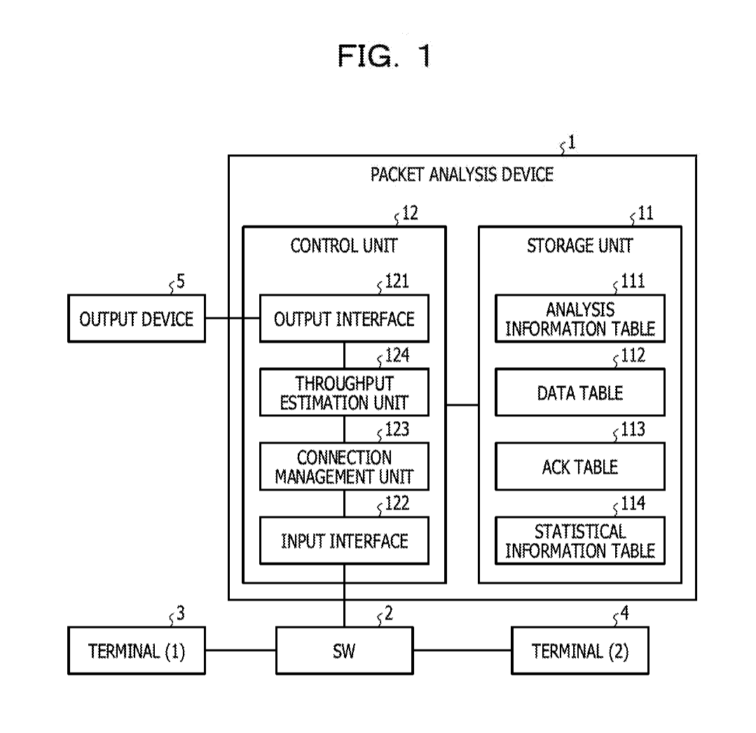

FIG. 1 a diagram illustrating functional configuration of a packet analysis device according to an embodiment. As illustrated in FIG. 1, a packet analysis device 1 acquires a packet which is communicated between a terminal 3 and a terminal 4 through an SW 2, and passively diagnoses a network bandwidth. The passive diagnosis is a diagnosis method of diagnosing a network bandwidth while a packet which flows through a network is set to a measurement target. Meanwhile, although a diagnosis method of diagnosing a network band includes active diagnosis in which a network band is diagnosed while setting a packet, which flows the network and has a prepared pattern, as a measurement target, in addition to passive diagnosis, the passive diagnosis is applied in the embodiment.

The terminals 3 and 4 perform communication using, for example, a transmission control protocol (TCP) on a network.

Here, an example of functional characteristics of TCP communication will be described. In a case in which the reception side-terminal 3 receives a data packet, the reception side-terminal 3 sets a data sequence number, which is supposed to be subsequently received, to an ACK acknowledgement number based on the sequence number and the data size of the data, and transfers ACK to the transmission side-terminal 4. The transmission side-terminal 4 receives ACK, checks the received ACK acknowledgement number, and then transmits a subsequent data packet.

However, if the transmission side-terminal 4 receives, checks, and transmits the data packet one by one, communication efficiency is low. Here, in TCP, “window control” is performed. In the window control, the transmission side-terminal 4 consecutively transmits a plurality of data packets instead of receiving, checking, and transmitting the data packet one by one. That is, the transmission side-terminal 4 manages the plurality of data packets in the unit of a window size called convergency window, and consecutively transmits the data packets without the ACK acknowledgement numbers. The communication efficiency is improved due to the window control. Meanwhile, the data packets, which are consecutively transmitted through the window control, are referred to as “consecutive packets” or “data packets corresponding to a group”. Meanwhile, it is possible to specify the number of consecutive packets according to content disclosed in, for example, Japanese Laid-open Patent Publication No. 2015-035709.

However, in network band diagnosis, the throughput of a TCP protocol (hereinafter referred to as “TCP throughput”) is estimated using round trip time (RTT) and the convergency window (cwind) as in Equation (1). Meanwhile, RTT refers to time until an ACK packet is returned after a data packet is transmitted, that is, indicates a round trip delay time. The convergency window refers to the amount of data of the data packets which flow within RTT. The amount of data of the data packets is managed in a unit of window size.

TCP throughput [bps]=cwind[bit]/RTT[sec] Equation (1)

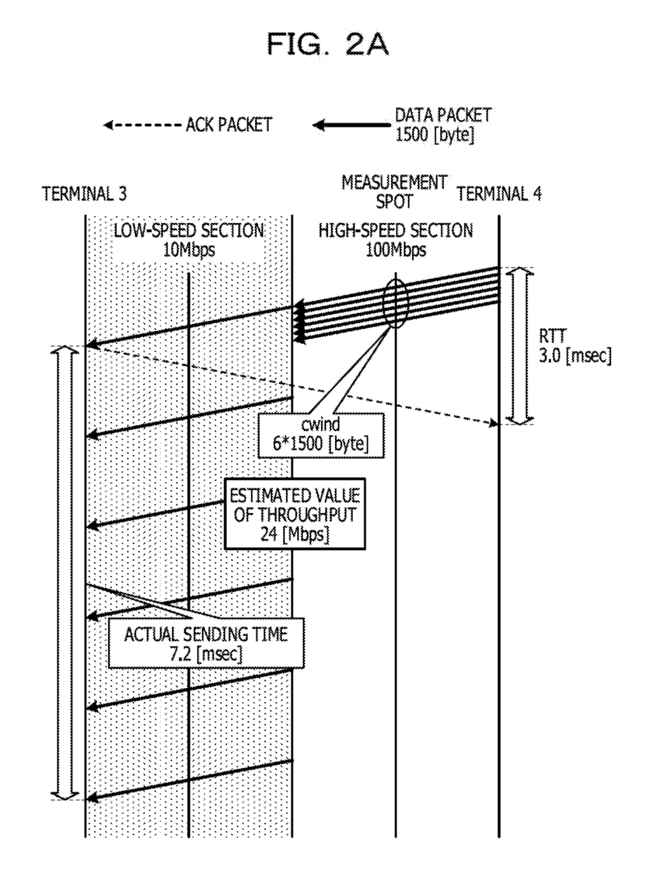

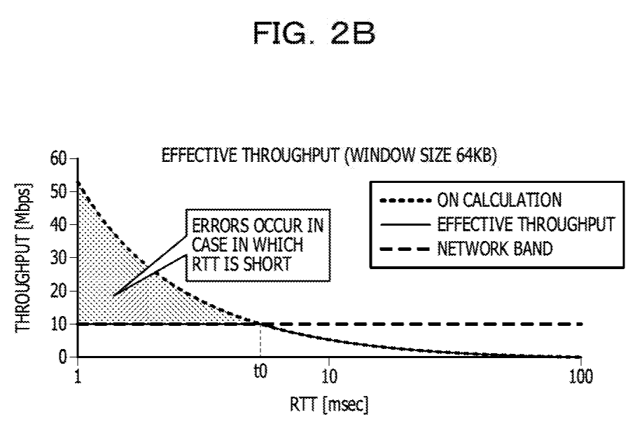

However, for example, in a case in which the reception side includes a low-speed section, RTT is short, or cwind is large, there is a problem in which the estimation accuracy of the TCP throughput is lowered. A case in which the reception side includes the low-speed section includes, for example, a case in which a physical band is narrow and network usage rate is high even though a network physical band is wide. The problem of TCP throughput estimation will be described with reference to FIGS. 2A and 2B.

FIGS. 2A and 2B are diagrams illustrating the problem of the TCP throughput estimation. As illustrated in FIG. 2A, the packet analysis device 1 measures the TCP throughput using RTT and cwind at a measurement spot. Here, the terminal 4, which is a transmission terminal, consecutively transmission six data packets, and the terminal 3, which is a reception terminal, transmits an ACK packet corresponding to an initial data packet. In this case, it is assumed that RTT is 3.0 [msec]. If it is assumed that the amount of data of one data packet is 1500 [byte], cwind is 6×1500 [byte]. If so, the packet analysis device 1 substitutes RTT and cwind for Equation (1), and measures that the estimated value of the TCP throughput is 24 Mbps. However, if it is assumed that a reception side-network band is 10 Mbps, the packet analysis device 1 estimates the estimated value (24 Mbps) of the TCP throughput as a value which is larger than the reception side-network band (10 Mbps). The reason for this is that, for example, in a case in which RTT is short, a case in which cwind is large, and a case in which the reception side includes the low-speed section, errors occur in the measured value of the TCP throughput.

A graph illustrated in FIG. 2B is a graph illustrating an effective throughput in a case in which an X axis is RTT [msec] and a Y axis is throughput [Mbps]. In the graph, the estimated value of the TCP throughput through the measurement is a value according to an inverse proportion curve which becomes large as RTT is short and becomes small as RTT is long. That is, in a case in which RTT is shorter than t0 even though the network band is 10 Mbps, the estimated value of the TCP throughput through the measurement is measured as a value which is larger than that of the network band. That is, errors occur in the measured value of the TCP throughput.

In contrast, in a case in which RTT is longer than t0, the estimated value of the TCP throughput through the measurement is measured as a value which is smaller than that of the network band. That is, it is estimated that the measured value of the TCP throughput coincides with the effective throughput.

Meanwhile, although the case in which RTT is short is described as an example of the case in which the estimated value of the TCP throughput through the measurement is measured as a value which is larger than that of the network band, the embodiment is not limited thereto. A cause of the case in which the estimated value of the TCP throughput through the measurement is measured as a value which is larger than that of the network band is the same in both the case in which cwind is large and the case in which the reception side includes a low-speed section.

Here, in the embodiment, the packet analysis device 1 determines the validity of the estimated value of the TCP throughput using the throughput which is measured based on an ACK interval, and accurately measures the effective throughput between the device 3 and the device 4. A method of measuring the effective throughput will be described later.

Returning to FIG. 1, the packet analysis device 1 includes a storage unit 11 and a control unit 12.

The storage unit 11 corresponds to, for example, a storage device such as a non-volatile semiconductor memory including a flash memory, a ferroelectric random access memory (FRAM,®), and the like. The storage unit 11 includes an analysis information table 111, a DATA table 112, an ACK table 113, and a statistical information table 114.

The analysis information table 111 stores analysis information. The analysis information table 111 is used when the network band is diagnosed. Meanwhile, a data structure of the analysis information table 111 will be described later.

In a case in which a data packet (hereinafter, referred to as “DATA”) is acquired, the DATA table 112 stores an index number, an arrival time, and a packet length of DATA. In a case in which an ACK packet (hereinafter, referred to as “ACK”) is acquired, the ACK table 113 stores an arrival time and an index number of DATA corresponding to ACK. Meanwhile, data structures of the respective DATA table 112 and the ACK table 113 will be described later.

The statistical information table 114 stores statistical information. The statistical information table 114 stores final statistical information of network band diagnosis. Meanwhile, a data structure of the statistical information table 114 will be described later.

The control unit 12 includes an internal memory in order to store a program, which defines various process procedures, and control data, and executes various processes using the program and the control data. Further, the control unit 12 corresponds to, for example, an electronic circuit of an integrated circuit such as an application specific integrated circuit (ASIC) and a field programmable gate array (FPGA). In addition, the control unit 12 corresponds to an electronic circuit such as a central processing unit (CPU) or a micro processing unit (MPU). Further, the control unit 12 includes an output interface 121, an input interface 122, a connection management unit 123, and a throughput estimation unit 124.

The output interface 121 is an interface with an output device 5. For example, the output interface 121 edits the statistical information, which is stored in the statistical information table 114, and the analysis information, which is stored in the analysis information table 111, and then outputs the edited statistical information to the output device 5.

The input interface 122 captures packets, which are communicated between the terminal 3 and the terminal 4, through SW 2. The input interface 122 delivers the captured packets to the connection management unit 123.

The connection management unit 123 manages the connection of the captured packets. For example, in a case in which a connection establishment method is a three way-handshake, the connection management unit 123 measures transmission-side round trip delay time using a SYN packet and a SYN/ACK packet in a case of connection establishment. As an example, the connection management unit 123 calculates time which, is taken from acquisition time of a SYN packet transmitted from the terminal 3 which is the reception terminal is acquired to acquisition time of the SYN/ACK packet transmitted from the terminal 4 which is the transmission terminal, as the transmission-side round trip delay time. The connection management unit 123 records the calculated transmission-side round trip delay time in the analysis information table 111.

In addition, in a case in which the captured packet is ACK, the connection management unit 123 adds ACK information associated with the acquisition time to the ACK table 113. In a case in which the captured packet is DATA, the connection management unit 123 adds DATA information associated with the acquisition time to the DATA table 112. Meanwhile, in the embodiment, a case in which the connection management unit 123 captures packets having the same connection information will be described. The connection information includes, for example, an IP address of a transmission source, a port number of the transmission source, an IP address of a destination, and a port number of the destination.

The throughput estimation unit 124 determines the validity of the estimated value of the TCP throughput using a throughput measured from the ACK interval. For example, the throughput estimation unit 124 calculates time which is taken to acquire ACK corresponding to initial DATA based on acquisition of the initial DATA corresponding to a group in which one or more consecutively transmitted DATA are collected. The throughput estimation unit 124 calculates the estimated value of the TCP throughput by substituting the calculated time and the amount of data of DATA of the group for Equation (1). In addition, the throughput estimation unit 124 calculates time which is taken from the acquisition of ACK corresponding to the initial DATA to acquisition of a final ACK corresponding to the group. The throughput estimation unit 124 calculates a throughput value using the calculated time and the amount of data (the amount of second packets) of DATA acquired by excluding the initial DATA from the group. The throughput value calculated as above indicates an approximate value of the network band. The throughput estimation unit 124 determines the validity of the estimated value of the TCP throughput by comparing the estimated value of the TCP throughput with approximate value of the network band. In a case in which it is determined that the estimated value of the TCP throughput has validity, the throughput estimation unit 124 specifies the estimated value of the TCP throughput as an effective throughput value.

In addition, in a case in which it is determined that the estimated value of the TCP throughput does not have validity, the throughput estimation unit 124 further determines the validity of the approximate value of the network band. For example, the throughput estimation unit 124 calculates time (second ACK interval) which is taken from the acquisition of ACK corresponding to the initial DATA to the acquisition of ACK of a subsequent group other than the group. The throughput estimation unit 124 estimates the throughput value which is measured based on the calculated second ACK interval, the amount of second packets, and the amount of data of DATA of the subsequent group. The throughput estimation unit 124 determines the validity of the approximate value of the network band by comparing the estimated value with the estimated value of the TCP throughput. That is, the packet analysis device 1 determines the validity of the approximate value of the network band using the second ACK interval including the ACK of the subsequent group other than the group. In a case in which it is determined that the approximate value of the network band does not have validity, the throughput estimation unit 124 specifies the estimated value of the TCP throughput as the effective throughput value. In a case in which the approximate value of the network band has validity, the throughput estimation unit 124 specifies the approximate value of the network band as the effective throughput value.

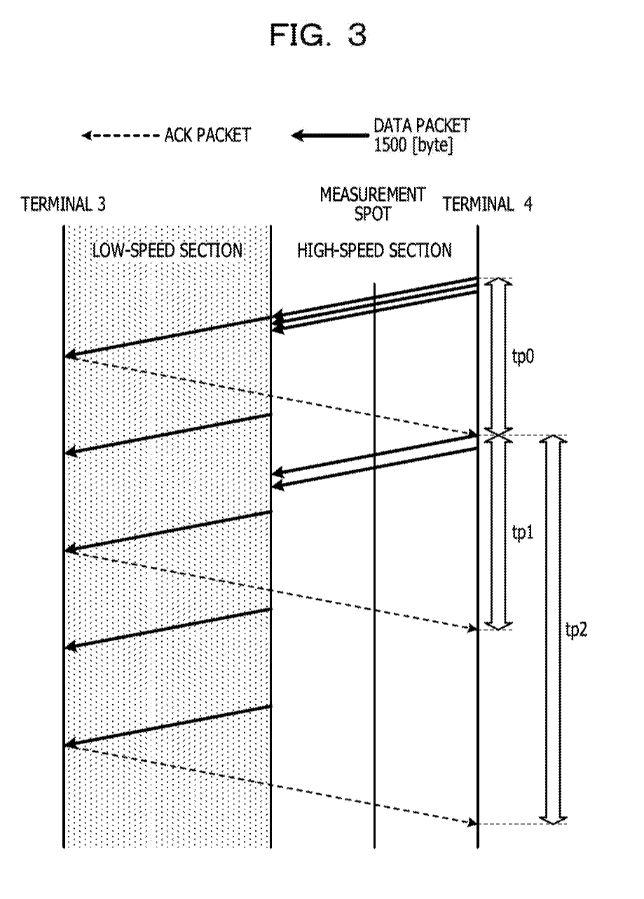

Here, a method of measuring the effective throughput by the throughput estimation unit 124 according to the embodiment will be described with reference to FIG. 3. FIG. 3 is a diagram illustrating a process performed by the throughput estimation unit according to the embodiment. As illustrated in FIG. 3, at a measurement spot, the throughput estimation unit 124 causes the terminal 4 which is the transmission terminal to transmit a group in which one or more DATA are collected to the terminal 3 which is the reception terminal. The throughput estimation unit 124 measures the estimated value of the TCP throughput using RTT corresponding to the initial DATA relevant to the group and the amount of data of DATA of the group. Here, RU is tp0. The amount of data of DATA of the group is cwind and is 1500×3 [byte].

The throughput estimation unit 124 calculates the approximate value of the network band using time, which is taken from acquisition of the initial ACK to acquisition of final ACK corresponding to group, and the amount of data of DATA acquired by excluding the initial DATA from the group. Here, the time, which is taken from acquisition of the initial ACK to acquisition of final ACK, that is, the ACK interval is tp1.

The throughput estimation unit 124 determines validity indicative of whether or not the estimated value of the TCP throughput is proper as the effective throughput by comparing the estimated value of the TCP throughput with the approximate value of the network band. That is, the throughput estimation unit 124 determines the validity of the estimated value of the TCP throughput using the throughput measured based on ACK interval in the group. If the estimated value of the TCP throughput is not larger than the approximate value of the network band, the throughput estimation unit 124 determines that the estimated value of the TCP throughput is valid, and specifies the estimated value of the TCP throughput as the effective throughput.

If the estimated value of the TCP throughput is larger than the approximate value of the network band, the throughput estimation unit 124 determines that the estimated value of the TCP throughput is not valid, and further determines validity indicative of whether or not the approximate value of the network band is proper as the effective throughput. For example, the throughput estimation unit 124 estimates the throughput value which is measured from the second ACK interval, which includes ACK of a subsequent group other than the group, and the amount of relevant data. Here, the second ACK interval is tp2. The throughput estimation unit 124 determines the validity of the approximate value of the network band by comparing the estimated value with the estimated value of the TCP throughput.

If the estimated value of the TCP throughput is larger than the throughput value measured from the second ACK interval, the throughput estimation unit 124 determines that the approximate value of the network band is valid, and specifies the approximate value of the network band as the effective throughput. If the estimated value of the TCP throughput is not larger than the throughput value measured from the second ACK interval, the throughput estimation unit 124 determines that the approximate value of the network band is not proper, and specifies the estimated value of the TCP throughput as the effective throughput.

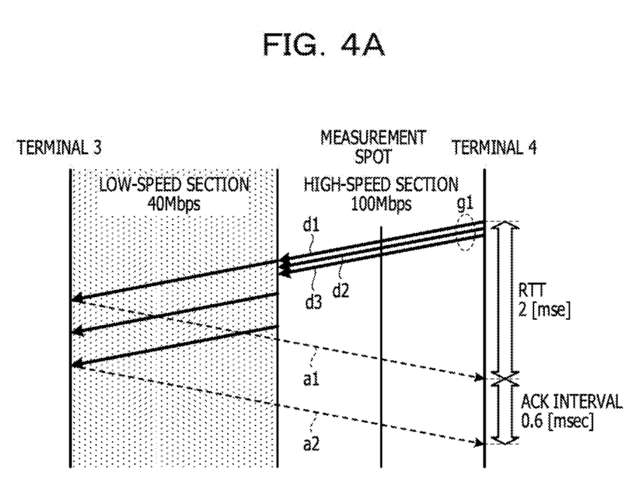

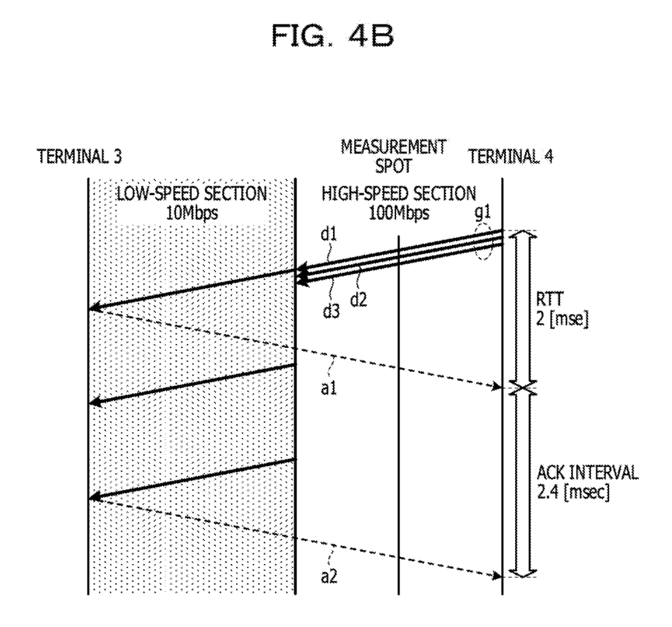

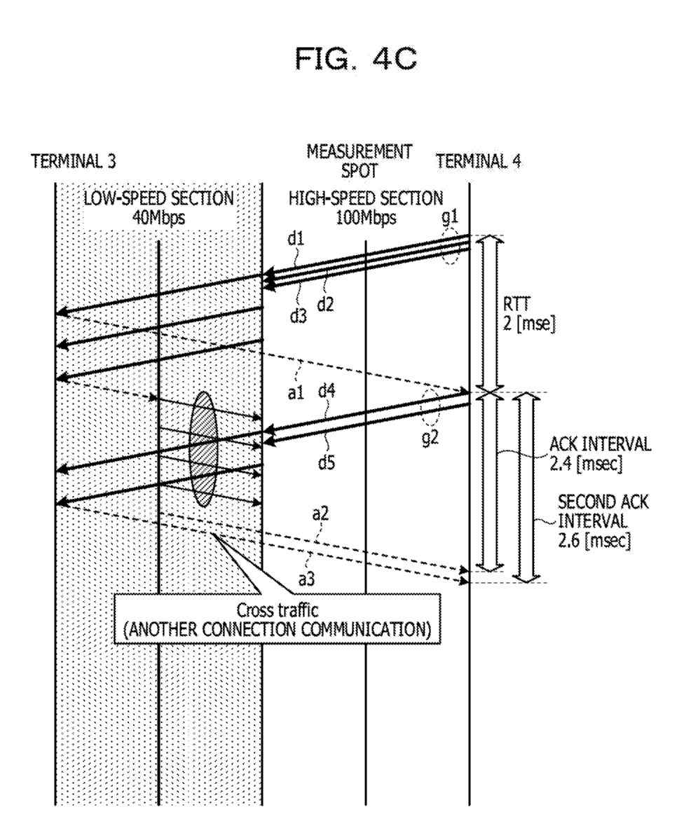

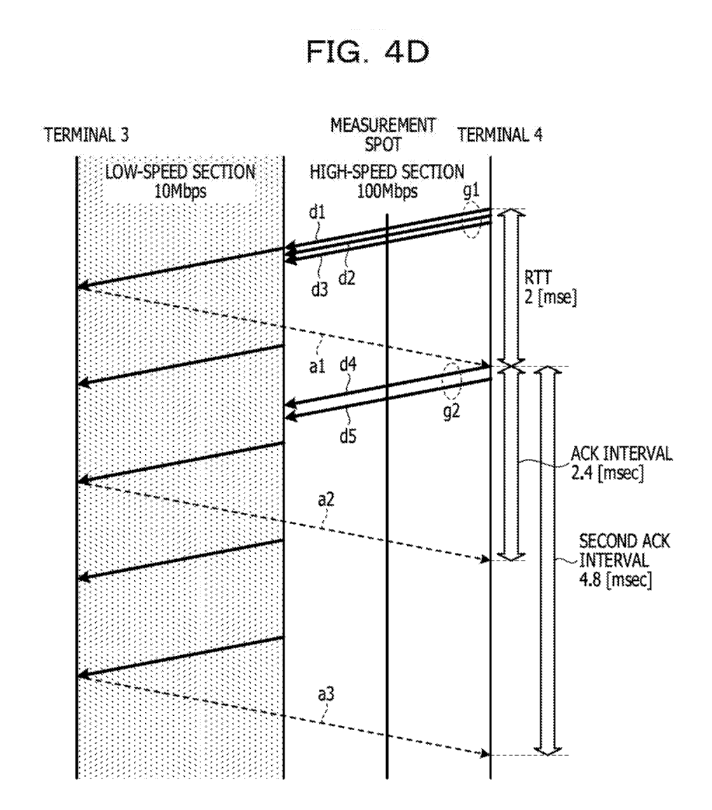

Subsequently, a detailed example of a process performed by the throughput estimation unit 124 according to the embodiment will be described with reference to FIGS. 4A to 4D. FIGS. 4A to 4D are diagrams illustrating the process performed by the throughput estimation unit according to the embodiment in detail.

As illustrated in FIG. 4A, three DATA are included in a group g1 in which DATA is collected. It is assumed that the amount of data of one DATA is 1500 bytes. RTT is 2 msec and the ACK interval is 0.6 msec.

The throughput estimation unit 124 calculates an estimated value TP_{tcp} of the TCP throughput by substituting RTT and cwind for Equation (1). Here, cwind is the amount of data of DATA d1 to d3 and is 8×(3×1500 [byte]) bits. RTT is 2 msec. The estimated value TP_{tcp} of the TCP throughput is calculated as follows.

TP_{tcp}=8×(3×1500 [byte])/2 [msec]=18 [Mbps] Equation (2)

The throughput estimation unit 124 calculates an approximate value TP_{rcv1} of the network band using the ACK interval and the amount of data of DATA acquired by excluding the initial DATA from the group. Here, the ACK interval is time which is taken from the acquisition of initial ACKa1 to the acquisition of final ACKa2 corresponding to the group. The amount of data of DATA is the amount of data (the amount of second packets) of DATA d2 and d3 acquired by excluding initial DATA d1 from the group g1, and is 8×(2×1500 [byte]) bits. The ACK interval is 0.6 msec. The approximate value TP_{rcv1} of the network band is calculated as follows.

TP_{rcv1}=8×(2×1500 [byte])/0.6 [msec]=40 [Mbps] Equation (3)

The throughput estimation unit 124 determines the validity of the estimated value of the TCP throughput by comparing the estimated value of the TCP throughput TP_{tcp} and the approximate value TP_{rcv1} of the network band. Since the estimated value TP_{rcv1} of the TCP throughput Tp_{tcp} is not larger than the approximate value TP_{rcv1} of the network band, the throughput estimation unit 124 specifies the estimated value TP_{tcp} of the TCP throughput as the effective throughput. That is, the estimated value TP_{tcp} of the TCP throughput is valid.

In the case, a reason that the estimated value TP_{tcp} of the TCP throughput is specified as the effective throughput is as follows. That is, in a case in which the low-speed section on the reception side is 40 Mbps, actual sending time in a case of sending DATA d1 to d3 is calculated as follows.

Actual sending time=8×(3×1500 [byte])/40 [Mbps]=0.9 [msec] Equation (4).

According to Equation, the actual sending time (0.9 msec) is short than RTT (2 msec) and waste time exists in the network. Therefore, the estimated value TP_{tcp} of the TCP throughput is specified as the effective throughput. That is, RTT is larger than t0 in the graph of FIG. 2B.

As illustrated in FIG. 4B, the number of DATA of the group g1 in which DATA are collected, the amount of data of one DATA, and RTT are the same as in FIG. 4A. FIG. 4B is different from FIG. 4A in that the ACK interval is changed from 0.6 msec to 2.4 msec.

The throughput estimation unit 124 substitutes RTT and cwind for Equation (1), and calculates the estimated value TP_{tcp} of the TCP throughput. Here, the estimated value TP_{tcp} of the TCP throughput is 18 [Mbps] as in FIG. 4A.

The throughput estimation unit 124 calculates the approximate value TP_{rcv1} of the network band using the ACK interval and the amount of data (the amount of second packet) of DATA acquired by excluding the initial DATA from the group g1. Here, the ACK interval is 2.4 msec. The approximate value TP_{rcv1} of the network band is calculated as follows.

TP_{rcv1}=8×(2×1500 [byte])/2.4 [msec]=10 [Mbps] Equation (5)

The throughput estimation unit 124 determines the validity of the estimated value of the TCP throughput by comparing the estimated value TP_{tcp} of the TCP throughput with the approximate value TP_{rcv1} of the network band. Since the estimated value TP_{tcp} of the TCP throughput larger than the approximate value TP_{rcv1} of the network band, the throughput estimation unit 124 determines that the estimated value of the TCP throughput TP_{tcp} is not valid, and further determines validity of the approximate value TP_{rcv1} of the network band.

In this case, the reason that the estimated value TP_{tcp} of the TCP throughput is not specified as the effective throughput is as follows. That is, in a case in which the low-speed section on the reception side is 10 Mbps, the actual sending time in which DATA d1 to d3 are sent is calculated as follows.

Actual sending time=8×(3×1500 [byte])/10 [Mbps]=3.6 [msec] Equation (6).

According to this, the actual sending time (3.6 msec) is longer than RTT (2 msec) and waste time does not exist in the network. Therefore, the estimated value TP_{tcp} of the TCP throughput is not specified as the effective throughput. That is, RTT is shorter than t0 in the graph of FIG. 2B. Further, the throughput estimation unit 124 continuously determines the validity of the approximate value TP_{rcv1} of the network band.

As illustrated in FIG. 4C, the number of DATA of the group g1 in which DATA are collected, the amount of data of one DATA, RTT, and the ACK interval are the same as in FIG. 4B. FIG. 4C is different from FIG. 4B in that two DATA are included in a subsequent group g2. FIG. 4C is different from FIG. 4B in that the second ACK interval is 2.6 msec.

The throughput estimation unit 124 substitutes RTT and cwind for Equation (1), and calculates the estimated value TP_{tcp} of the TCP throughput. Here, the estimated value TP_{tcp} of the TCP throughput is 18 [Mbps] as in FIG. 4B.

The throughput estimation unit 124 calculates the approximate value TP_{rcv1} of the network band using the ACK interval and the amount of data of DATA acquired by excluding the initial DATA from the group. Here, the approximate value TP_{rcv1} of the network band is 10 [Mbps] as in FIG. 4B.

Since the estimated value TP_{tcp} of the TCP throughput is larger than the approximate value TP_{rcv1} of the network band, the throughput estimation unit 124 determines that the estimated value TP_{tcp} of the TCP throughput is not valid, and determines the validity of the approximate value TP_{rcv1} of the network band as below. The throughput estimation unit 124 calculates a throughput value T_{Prcv2} which is measured using the second ACK interval, the amount of second packet, and the amount of data of DATA d4 and d5 of the subsequent group g2. Here, the second ACK interval is 2.6 msec. The amount of second packet is 8×(2×1500 [byte]) bits. The amount of data of DATA d4 and d5 of the subsequent group g2 is also 8×(2×1500 [byte]) bits. The throughput value TP_{rcv2} is calculated as below.

TP_{rcv2}=8×(4×1500 [byte])/2.6 [msec]=19.2 [Mbps] Equation (7)

Since the estimated value TP_{tcp} of the TCP throughput is not larger than the throughput value measured from the second ACK intervalTPrcv2, the throughput estimation unit 124 specifies the estimated value TP_{tcp} of the TCP throughput as the effective throughput. That is, the approximate value TP_{rcv1} of the network band is not valid although the approximate value TP_{rcv1} of the network band is smaller than the estimated value TP_{tcp} of the TCP throughput.

In this case, a reason that the approximate value TP_{rcv1} of the network band is not specified as the effective throughput and the estimated value TP_{tcp} of the TCP throughput is specified as the effective throughput is as follows. That is, the ACK interval is only widened by cross traffics (disturbance), actual sending time (0.9 msec), which is calculated in Equation (4), is shorter than RTT (2 msec) even in the low-speed section, and thus waste time exists in the network. Therefore, the approximate value TP_{rcv1} of the network band is not proper as the effective throughput in the low-speed section, and the estimated value TP_{tcp} of the TCP throughput is specified as the effective throughput.

As illustrated in FIG. 4D, the number of DATA of the group g1, in which DATA are collected, the amount of data of one DATA, RTT, the ACK interval, and the number of DATA of the subsequent group g2 are the same as in FIG. 4C. FIG. 4D is different from FIG. 4C in that the second ACK interval is 4.8 msec.

The throughput estimation unit 124 substitutes RTT and cwind for Equation (1), and calculates the estimated value TP_{tcp} of the TCP throughput. Here, the estimated value TP_{tcp} of the TCP throughput is 18 [Mbps] as in FIG. 4C.

The throughput estimation unit 124 calculates the approximate value TP_{rcv1} of the network band using the ACK interval and the amount of data of DATA acquired by excluding the initial DATA from the group. Here, the approximate value TP_{rcv1} of the network band is 10 [Mbps] as in the case of FIG. 4C.

Since the estimated value TP_{tcp} of the TCP throughput is larger than the approximate value TP_{rcv1} of the network band, the throughput estimation unit 124 determines that the estimated value TP_{tcp} of the TCP throughput is not valid, and determines validity of the approximate value TP_{rcv1} of the network band as below. The throughput estimation unit 124 calculates the second ACK interval, and the throughput value TP_{rcv2} which is measured from the amount of second packet and the amount of data of DATA d4 and d5 of the subsequent group g2. Here, the second ACK interval is 4.8 msec. The amount of second packet is 8×(2×1500 [byte]) bits. The amount of data of DATA d4 and d5 of the subsequent group g2 is also 8×(2×1500 [byte]) bits. The throughput value TP_{rcv2} is calculated as below.

TP_{rcv2}=8×(4×1500 [byte])/4.8 [msec]=10 [Mbps] Equation (8)

Since the estimated value TP_{tcp} of the TCP throughput is larger than the throughput value measured from the second ACK interval TP_{rcv2}, the throughput estimation unit 124 specifies the approximate value TP_{rcv1} of the network band as the effective throughput. That is, the approximate value TP_{rcv1} of the network band is valid.

In this case, a reason that the approximate value TP_{rcv1} of the network band is specified as the effective throughput is as follows. That is, the second ACK interval, which is the ACK interval of a subsequent packet, is widened, and the throughput in the low-speed section is measured as a low value. In addition, actual sending time in a case in which DATA d1 to d3 are sent is 3.6 msec as expressed in Equation (9) below. That is, the actual sending time is longer than RTT (2 msec), and thus waste time does not exist in the network.

Actual sending time=8×(3×1500 [byte])/10 [Mbps]=3.6 [msec] Equation (9)

Therefore, there is a high probability that the approximate value TP_{rcv1} of the network band is proper as a throughput in the low-speed section, and thus the approximate value TP_{rcv1} of the network band is specified as the effective throughput.

[Data Structure of Table]

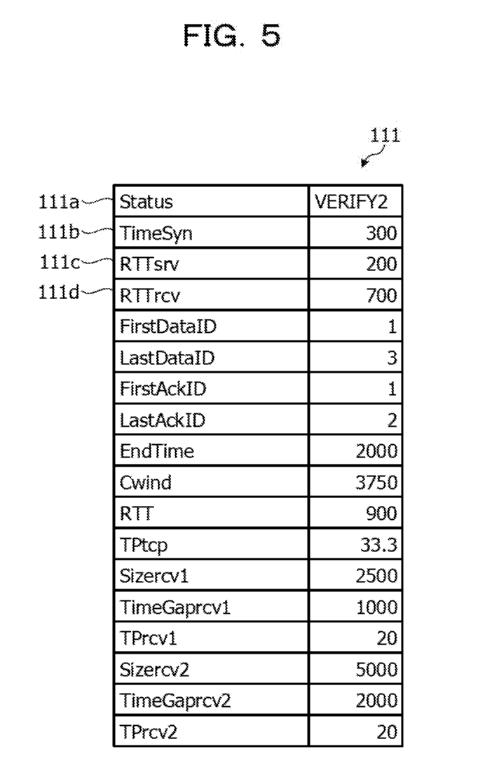

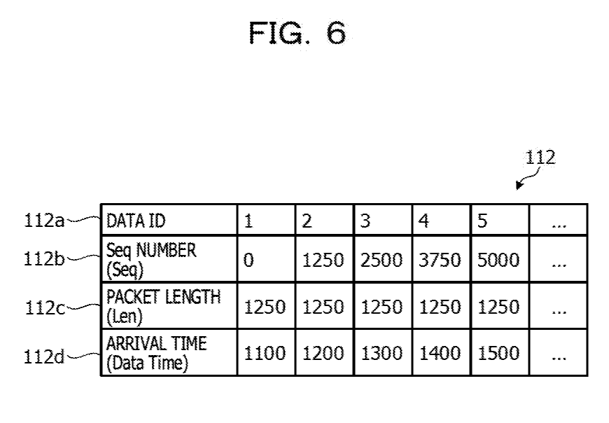

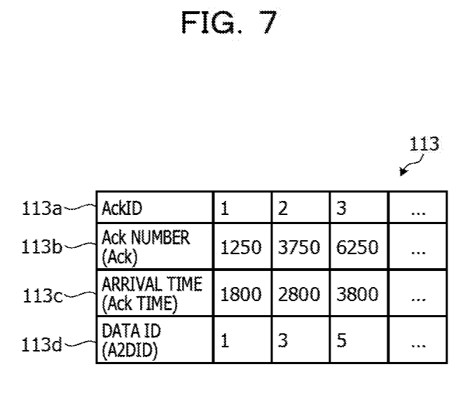

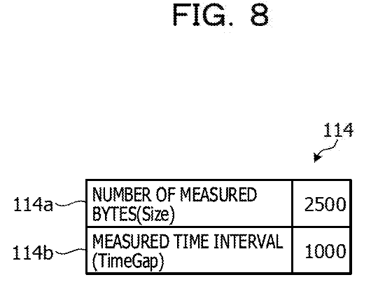

Data structures of various tables which are used in the packet analysis device 1 will be described with reference to FIGS. 5 to 8. FIG. 5 is a diagram illustrating an example of a data structure of an analysis information table. FIG. 6 is a diagram illustrating an example of a data structure of a DATA table. FIG. 7 is a table illustrating an example of a data structure of an ACK table. FIG. 8 is a table illustrating an example of a data structure of a statistical information table.

As illustrated in FIG. 5, the analysis information table 111 stores a Status 111a, a TimeSyn 111b, a RTTsrv 111c, and an RTTrcv 111d through association. In addition, the analysis information table 111 temporally stores various pieces of analysis information.

The Status 111a indicates the measurement state of band measurement and a current status. In the Status 111a, for example, “INIT”, “MEASURE”, “VERIFY1”, and “VERIFY2” are set. “INIT” indicates an initial value. “MEASURE” indicates that band measurement is being performed. “VERIFY1” indicates that the validity of the TCP throughput is being determined. “VERIFY2” indicates that the validity of the network band is being determined.

The TimeSyn 111b indicates the arrival time of the SYN packet. The RTTsry 111c indicates transmission-side round trip delay time, and indicates time from the arrival of the SYN packet to the arrival of the SYN/ACK packet. The RTTrcv 111d indicates reception-side round trip delay time, and indicates time from arrival of DATA to arrival of ACK.

As illustrated in FIG. 6, the DATA table 112 stores a data ID 112a, a Seq number 112b, a packet length 112c, and an arrival time 112d through association. The data ID 112a is an index number of DATA. The Seq number 112b is a sequence number of DATA. The packet length 112c is a packet length of DATA. The arrival time 112d is time in which DATA arrives at the packet analysis device 1.

As an example, in a case in which the data ID 112a is “1”, “0” is stored as the Seq number 112b, “1250” is stored as the packet length 112c, and “1100” is stored as the arrival time 112d. In addition, in a case in which the data ID 112a is “2”, “1250” is stored as the Seq number 112b, “1250” is stored as the packet length 112c, and “1200” is stored as the arrival time 112d.

As illustrated in FIG. 7, the ACK table 113 stores an AckID 113a, an Ack number 113b, an arrival time 113c, and a data ID 113d through association. The AcKID 113a is an index number of ACK. The Ack number 113b is Ack number (Acknowledgement number) of ACK. That is, the Seq number of DATA which is supposed to be subsequently sent is set to the Ack number 113b. The arrival time 113c is the arrival time of ACK at the packet analysis device 1. The data ID 113d is an index number (data ID) of DATA corresponding to ACK. That is, the data ID 113d means DATA corresponding to ACK which is indicated by the AckID 113a.

As an example, in a case in which the AckID 113a is “1”, “1250” is stored as the Ack number 113b, “1800” is stored as the arrival time 113c, and “1” is stored as the data ID 113d. In a case in which the AckID 113a is “2”, “3750” is stored as the Ack number 113b, “2800” is stored as the arrival time 113c, and “3” is stored as the data ID 113d.

As illustrated in FIG. 8, the statistical information table 114 stores a measured byte number 114a and a measured time interval 114b through association. The measured byte number 114a is the sum of the packet sizes of the measured consecutive packets. The measured time interval 114b is the sum of the arrival time intervals between packets of the measured consecutive packets. As an example, “2500” is stored as the measured byte number 114a, and “1000” is stored as the measured time interval 114b.

[Flowchart of Packet Analysis Process]

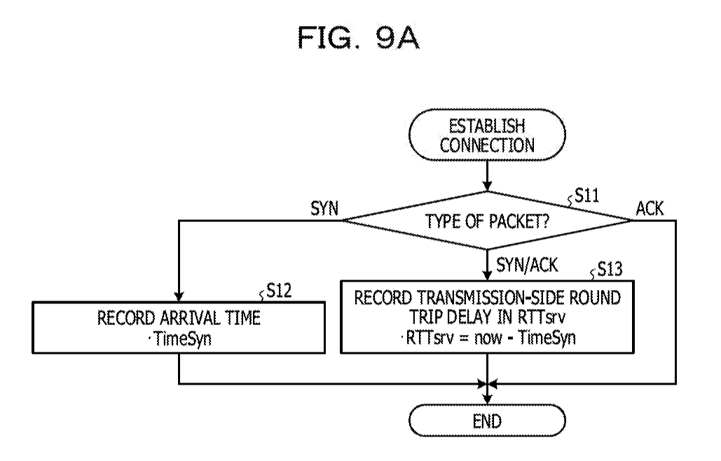

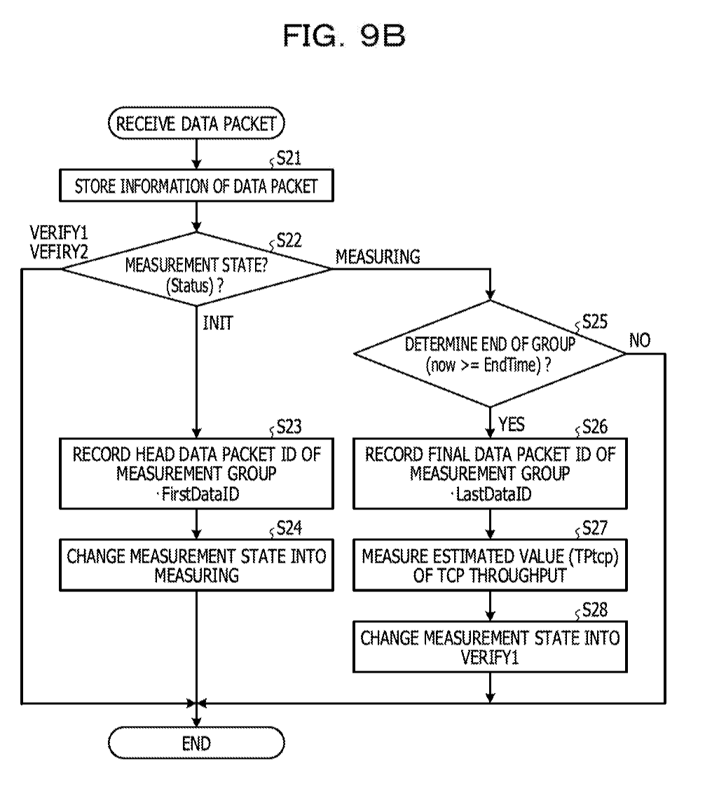

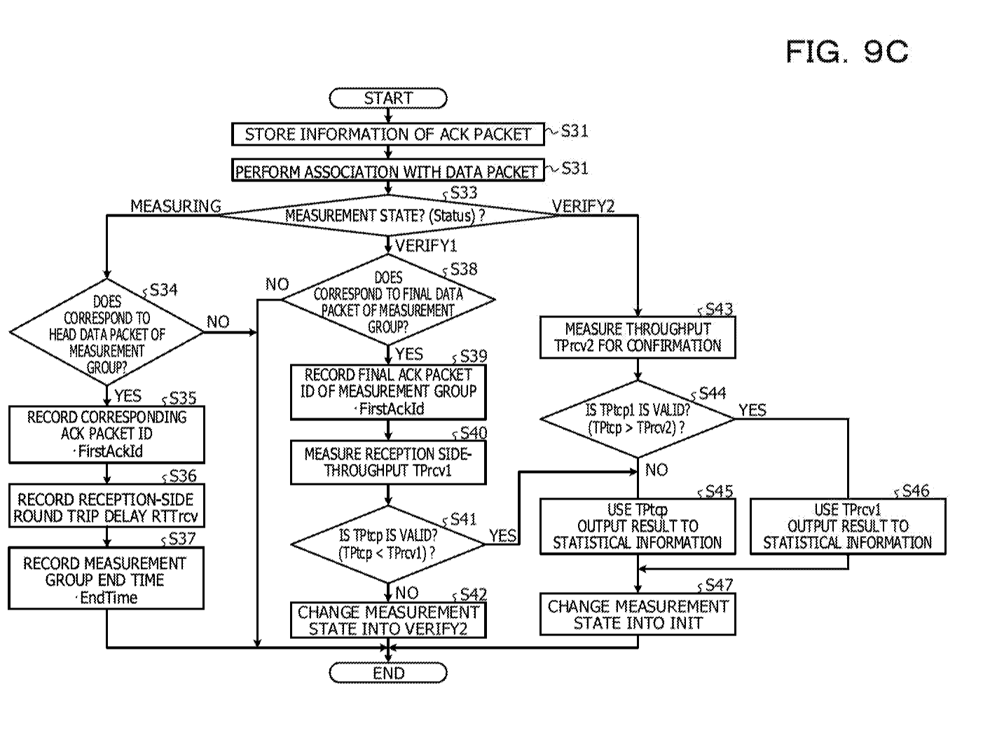

Subsequently, a flowchart of the packet analysis process according to the embodiment will be described with reference to FIGS. 9A to 9C. FIG. 9A is a flowchart illustrating a process performed in a case of connection establishment according to the embodiment. FIG. 9B is a flowchart illustrating a process performed in a case of data packet reception. FIG. 9C is a flowchart illustrating a process performed in a case of ACK packet reception. Meanwhile, there is a case in which a connection establishment method is three-way handshake.

[Flowchart of Connection Establishment Process]

As illustrated in FIG. 9A, the connection management unit 123 determines the type of a captured packet (step S11). In a case in which it is determined that the type of the packet is an SYN packet (step S11; SYN), the connection management unit 123 records arrival time of the SYN packet in the TimeSyn 111b of the analysis information table 111 (step S12). Furthermore, the connection management unit 123 ends the connection establishment process.

In a case in which it is determined that the type of the packet is an SYN/ACK packet (step S11; SYN/ACK), the connection management unit 123 records transmission-side round trip delay in the RTTsry 111c of the analysis information table 111 (step S13). For example, the connection management unit 123 acquires a value which is acquired by subtracting the TimeSyn 111b of the analysis information table 111 from the arrival time of the SYN/ACK packet. The connection management unit 123 records the acquired value in the RTTsry 111c of the analysis information table 111 as the transmission-side round trip delay. Furthermore, the connection management unit 123 ends the connection establishment process.

In a case in which it is determined that the type of the packet is an ACK packet (step S11; ACK), the connection management unit 123 does nothing and ends the connection establishment process.

[Flowchart of Data Packet Reception Process]

As illustrated in FIG. 9B, in a case in which the connection management unit 123 receives the DATA packet, the connection management unit 123 stores information of the DATA packet (DATA) in the DATA table 112 (step S21). The information of DATA includes, for example, an ID (data ID 112a), a sequence number (Seq number 112b), a packet length (packet length 112c), and arrival time (arrival time 112d) at a DATA measurement spot of the received DATA. The measurement spot means the packet analysis device 1.

The throughput estimation unit 124 determines a measurement state of the band measurement (step S22). For example, the throughput estimation unit 124 determines the measurement state with reference to the Status 111a of the analysis information table 111.

In a case in which the measurement state is “INIT” indicative of an initial value (step S22; INIT), the throughput estimation unit 124 records a data ID of head DATA of a measurement group in the First Data ID of the analysis information table 111 (step S23). Furthermore, the throughput estimation unit 124 changes the measurement state (Status 111a) of the analysis information table 111 to “MEASURING” which indicates that the band is being measured (step S24), and ends the process performed in the case of the data packet reception.

In a case in which the measurement state is “VERIFY1” or “VERIFY2” (step S22; VERIFY1, VERIFY2), the throughput estimation unit 124 ends the process performed in the case of the data packet reception. “VERIFY1” indicates that the validity of the TCP throughput is being determined. “VERIFY2” indicates that the validity of the network band is being determined.

In a case in which the measurement state is “MEASURING” (step S22; MEASURING), the throughput estimation unit 124 determines whether or not the received DATA indicates the end of the measurement group (step S25). For example, the throughput estimation unit 124 determines whether or not current time is more than End time of the analysis information table 111. The End Time is time in which the measurement group ends, and is recorded in the analysis information table 111 in the process performed in the case of ACK packet reception.

In a case in which it is determined that the received DATA does not indicate the end of the measurement group (step S25; No), the throughput estimation unit 124 ends the process performed in the case of the data packet reception.

In contrast, in a case in which it is determined that the received DATA indicates the end of the measurement group (step S25; Yes), the throughput estimation unit 124 records an ID of a final DATA packet of the measurement group in LastDataID of the analysis information table 111 (step S26).

Furthermore, the throughput estimation unit 124 measures the estimated value (TP_{tcp}) of the TCP throughput (step S27), and records the estimated value (TP_{tcp}) in TPtcp of the analysis information table 111. For example, the throughput estimation unit 124 calculates cwind and RTT, and records the calculated cwind and RTT in the analysis information table 111. The throughput estimation unit 124 calculates TP_{tcp} using the calculated cwind and RTT. cwind is calculated through Equation (10). Meanwhile, FirstDataID and LastDataID are stored in the analysis information table 111. Len (packet length) of each DataID is stored in the DATA table 112.

$$CWind = {\sum }_{i = FirstDataID}^{LastDataID} Len [ i ] \qquad Equation ( 10 )$$

RTT is calculated through Equation (11). Meanwhile, RTTsry (transmission-side round trip delay) and RTTrcv (reception side round trip delay) are stored in the analysis information table 111.

RTT=RTTsrv+RTTrcv Equation (11)

TP_{tcp} is calculated through Equation (1).

The throughput estimation unit 124 changes the measurement state (Status 111a) of the analysis information table 111 into “VERIFY1” which indicates that the validity of the TCP throughput is being determined (step S28), and ends the process performed in the case of the data packet reception.

[Flowchart of ACK Packet Reception Process]

As illustrated in FIG. 9C, in a case in which the connection management unit 123 receives an ACK packet, the connection management unit 123 stores information of the ACK packet (ACK) in the ACK table 113 (step S31). The information of ACK includes, for example, an ACK ID (AckID 113a), an ACK number (Ack number 113b), and arrival time (arrival time 113c) at an ACK measurement spot. The measurement spot means the packet analysis device 1.

The connection management unit 123 associates the received ACK packet with the DATA packet (step S32). For example, the connection management unit 123 searches for the data ID 112a, which satisfies the following conditions, using the ACK number of the received ACK packet, the Seq number 112b (Seq) of the DATA table 112, and the packet length 112c (Len).

Ack[current AckID]=Seq[data ID]+Len[data ID] Equation (12)

Furthermore, the connection management unit 123 records the data ID 112a, which satisfies the conditions, in the data ID 113d of the ACK table 113.

Subsequently, the throughput estimation unit 124 determines the measurement state of the band measurement (step S33). For example, the throughput estimation unit 124 determines the measurement state with reference to the Status 111a of the analysis information table 111.

In a case in which the measurement state is “MEASURING” (step S33; MEASURING), the throughput estimation unit 124 determines whether or not the received ACK packet corresponds to the head DATA packet of the measurement group (step S34). In a case in which the received ACK packet does not correspond to the head DATA packet of the measurement group (step S34; No), the throughput estimation unit 124 ends the process performed in the case of the ACK packet reception.

In contrast, in a case in which the received ACK packet corresponds to the head DATA of the measurement group (step S34; Yes), the throughput estimation unit 124 records an ACK ID corresponding to the head DATA of the measurement group in FirstAckID of the analysis information table 111 (step S35). The throughput estimation unit 124 records the reception-side round trip delay in the RTTrcv 111d of analysis information table 111 (step S36). For example, the throughput estimation unit 124 calculates the reception-side round trip delay RTTrcv from the arrival time of the head DATA of the measurement group and the arrival time of ACK corresponding to DATA through Equation (13). Meanwhile, AckTime (arrival time) is stored in the ACK table 113. DataTime (arrival time) is stored in the DATA table 112. FirstDataID is stored in the analysis information table 111.

RTTrcv=AckTime[current AckID]−DataTime[FirstAckID] Equation (13)

The throughput estimation unit 124 records the end time of the measurement group in EndTime of the analysis information table 111 (step S37). For example, the throughput estimation unit 124 calculates the end time of the measurement group as in Equation (14). Meanwhile, AckTime is stored in the ACK table 113. FirstAckID and RTTsry are stored in the analysis information table 111.

EndTime=AckTime[FirstAckID]−RTTsrv Equation (14)

Furthermore, the throughput estimation unit 124 ends the process performed in the case of the ACK packet reception.

In the case in which the measurement state is “VERIFY1” (step S33; VERIFY1), the throughput estimation unit 124 determines whether or not the received ACK packet corresponds to the final DATA packet of the measurement group (step S38). In a case in which the received ACK packet does not correspond to the final DATA packet of the measurement group (step S38; No), the throughput estimation unit 124 ends the process performed in the case of the ACK packet reception.

In contrast, in a case in which the received ACK packet corresponds to the final DATA packet of the measurement group (step S38; Yes), the throughput estimation unit 124 records an ID of ACK corresponding to the final DATA of the measurement group in LastAckID of the analysis information table 111 (step S39).

Furthermore, the throughput estimation unit 124 measures the reception side-throughput TP_{rcv1} (step S40), and records the reception side-throughput TP_{rcv1} in TP_{rcv1} of the analysis information table 111. That is, the throughput estimation unit 124 measures the approximate value TP_{rcv1} of the network band. For example, the throughput estimation unit 124 calculates the ACK interval (TimeGaprcv1) and the amount of data (Sizercv1) of DATA acquired by excluding the initial DATA from the measurement group, and stores the ACK interval (TimeGaprcv1) and the amount of data (Sizercv1) of DATA in the analysis information table 111. The throughput estimation unit 124 calculates TP_{rcv1} using the calculated ACK interval and the amount of data. The amount of data is calculated through Equation (15). Meanwhile, Ack is stored in the ACK table 113. FirstAckID and LastAckID are stored in the analysis information table 111.

Sizercv1=Ack[LastAckID]−Ack[FirstAckID] Equation (15)

The ACK interval is calculated through Equation (16). Meanwhile, AckTime is stored in the ACK table 113. LastAckID and FirstAckID are stored in the analysis information table 111.

TimeGaprcv1=AckTime[LastAckID]−AckTime[FirstAckID] Equation (16)

TP_{rcv1} is calculated through Equation (17).

TP_{rcv1}=Sizercv1/TimeGaprcv1 Equation (17)

Subsequently, the throughput estimation unit 124 determines whether or not TP_{tcp} is valid (step S41). For example, the throughput estimation unit 124 determines whether or not TP_{tcp} is smaller than TP_{rcv1} with reference to the analysis information table 111. In a case in which it is determined that TP_{tcp} is valid (step S41; Yes), the throughput estimation unit 124 proceeds to step S45. For example, TP_{tcp} is smaller than TP_{rcv1}.

In contrast, it is determined that TP_{tcp} is not valid (step S41; No), the throughput estimation unit 124 changes the measurement state (Status 111a) of the analysis information table 111 into “VERIFY2” (step S42), and ends the process performed in the case of the ACK packet reception. For example, TP_{tcp} is equal to or larger than TP_{rcv1}.

In step S33, in a case in which the measurement state is “VERIFY2” (step S33; VERIFY2), the throughput estimation unit 124 measures the throughput TP_{rcv2} for confirmation (step S43), and records the throughput TP_{rcv2} for confirmation in TPrcv2 of the analysis information table 111. For example, the throughput estimation unit 124 calculates the second ACK interval (TimeGaprcv2) and the amount of data (Sizercv2) of DATA of a subsequent group of the measurement group, and records the second ACK interval (TimeGaprcv2) and the amount of data (Sizercv2) in the analysis information table 111. The throughput estimation unit 124 calculates TP_{rcv2} using ng the calculated second ACK interval and the amount of data. The amount of data is calculated through Equation (18). Meanwhile, Ack is stored in the ACK table 113. FirstAckID and LastAckID are stored in the analysis information table 111.

Sizercv2=Ack[LastAckID+1]−Ack[FirstAckID] Equation (18)

The second ACK interval is calculated through Equation (19). Meanwhile, AckTime is stored in the ACK table 113. LastAckID and FirstAckID are stored in analysis information table 111.

TimeGaprcv2=AckTime[LastAckID+1]−AckTime[FirstAckID] Equation (19)

TP_{rcv2} is calculated through Equation (20).

TP_{rcv2}=Sizercv2/TimeGaprcv2 Equation (20)

Subsequently, the throughput estimation unit 124 determines whether or not TP_{rcv1} is valid (step S44). For example, the throughput estimation unit 124 determines whether or not TP_{tcp} is larger than TP_{rcv2} with reference to the analysis information table 111. In a case in which it is determined that TP_{rcv1} is not valid (step S44; No), the throughput estimation unit 124 proceeds to step S45. For example, TP_{tcp} is equal to or smaller than TP_{rcv2}.

In step S45, the throughput estimation unit 124 uses TP_{tcp} as the effective throughput, and outputs a result to the statistical information table 114 (step S45). That is, the throughput estimation unit 124 records Cwind of the analysis information table 111 in the measured byte number 114a of the statistical information table 114. The throughput estimation unit 124 records RTT in the measured time interval 114b of the statistical information table 114 in the analysis information table 111. Furthermore, the throughput estimation unit 124 proceeds to step S47.

In contrast, in a case in which it is determined that TP_{rcv1} is valid (step S44; Yes), the throughput estimation unit 124 uses TP_{rcv1} as the effective throughput, and outputs a result to the statistical information table 114 (step S46). That is, the throughput estimation unit 124 records Sizercv1 of the analysis information table 111 in the measured byte number 114a of the statistical information table 114. The throughput estimation unit 124 records TimeGaprcv1 of the analysis information table 111 in the measured time interval 114b of the statistical information table 114. Furthermore, the throughput estimation unit 124 proceeds to step S47.

In step S47, the throughput estimation unit 124 changes the measurement state (Status 111a) of the analysis information table 111 into “INIT” (step S47), and ends the process performed in the case of the ACK packet reception.

[Detailed Example of Packet Analysis Device]

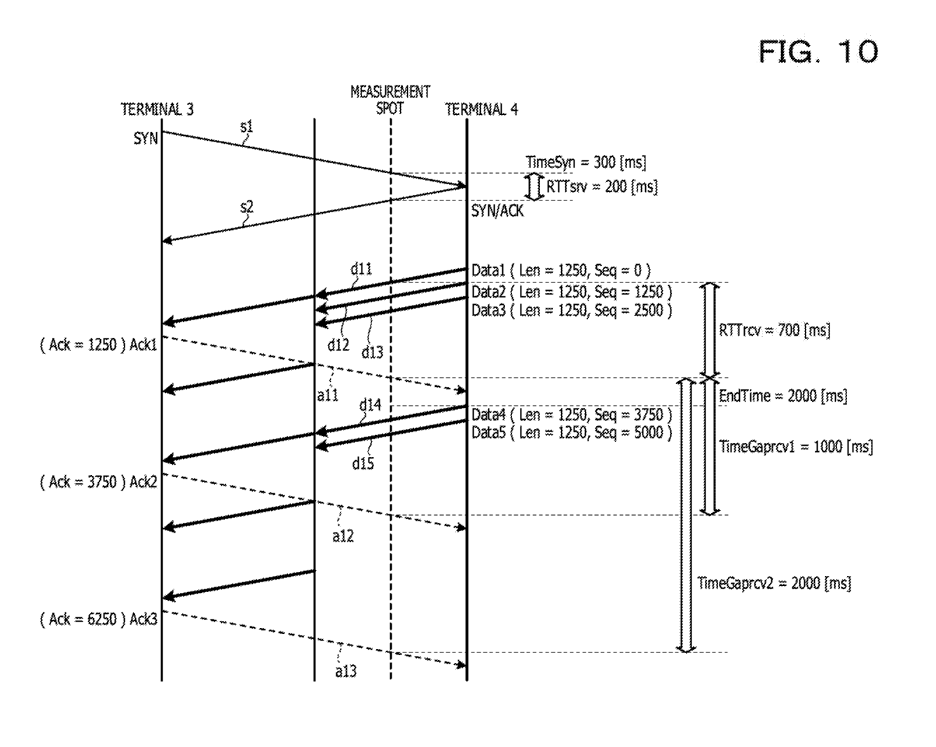

Subsequently, a detailed example of the process performed by the packet analysis device according to the embodiment will be described with reference to FIG. 10. FIG. 10 is a diagram illustrating the detailed example of the process performed by the packet analysis device according to the embodiment. Meanwhile, “INIT” is stored in the Status 111a of the analysis information table 111. In addition, it is assumed that the measurement group includes Data d11 to Data d13 in FIG. 10.

First, the packet analysis device 1 calculates transmission-side round trip delay RTTsry based on the arrival time TimeSyn of an SYN packet s1 and the arrival time of an SYN/ACK packet s2. Here, in a case in which TimeSyn is 300 and the arrival time of the SYN/ACK packet s2 is 500, a value 200, which is a value acquired by subtracting 300 from 500, is acquired as the transmission-side round trip delay RTTsrv.

Subsequently, in a case in which the packet analysis device 1 receives DATA d11, the packet analysis device 1 stores the information of the DATA d11 in the DATA table 112. Here, “1” is stored as the data ID 112a, “1250” is stored as the Len (packet length) 112c, “0” is stored as the Seq (Seq number) 112b, and “1100” is stored as the arrival time 112d. Furthermore, since the Status 111a of the analysis information table 111 is “INIT”, the packet analysis device 1 registers “1”, which is the data ID 112a of the head DATA of the measurement group, in FirstDataID of the analysis information table 111. Furthermore, the packet analysis device 1 changes the Status 111a of the analysis information table 111 into “MEASURING”.

Subsequently, in a case in which the packet analysis device 1 consecutively receives the DATA d12 and DATA d13 of the measurement group, the packet analysis device 1 stores the information of the DATA d12 and the information of the DATA d13 in the DATA table 112, respectively. Here, with regard to the DATA d12, “2” is stored as the data ID 112a, “1250” is stored as the Len (packet length) 112c, “1250” is stored as the Seq (Seq number) 112b, and “1200” is stored as the arrival time 112d. With regard to the DATA d12, “3” is stored as the data ID 112a, “1250” is stored as the Len (packet length) 112c, “2500” is stored as the Seq (Seq number) 112b, and “1300” is stored as the arrival time 112d.

Subsequently, in a case in which the packet analysis device 1 receives ACKa11, the packet analysis device 1 stores information of ACKa11 in the ACK table 113. Here, “1” is stored as the AckID 113a, “1250” is stored as the Ack (Ack number) 113b, and “1800” is stored as the AckTime (arrival time) 113c. Furthermore, the packet analysis device 1 associates the received ACKa11 with DATA. Here, the Ack (Ack number) 113b of ACKa11 is 1250. In a case in which the data ID 112a of the DATA table 112 is “1”, the Seq number (Seq) 112b is 0 and the packet length (Len) 112c is 1250. Therefore, since the packet analysis device 1 satisfies the condition of Equation (12), the packet analysis device 1 records “1”, which is stored as the data ID 112a, in the data ID 113d of the ACK table 113.

Furthermore, since the Status 111a is “MEASURING” and the received ACKa11 corresponds to the head DATA of the measurement group, the packet analysis device 1 records “1”, which is the AckID 113a of the ACKa11, in FirstAckID of the analysis information table 111. Furthermore, the packet analysis device 1 calculates the reception-side round trip delay RTTrcv. Here, in a case in which the current AckID 113a is 1, the arrival time (AckTime) 113c is 1800. In a case in which the data ID 112a is FirstDataID (1), the arrival time (DataTime) 112d is 1100. Therefore, packet analysis device 1 calculates RTTrcv as 700 using Equation (13).

Subsequently, since the DATA d13 indicates the end of the measurement group, the packet analysis device 1 records “3”, which is the data ID 112a of the final DATA of the measurement group in LastDataID of the analysis information table 111. Furthermore, the packet analysis device 1 measures the estimated value TPtcp of the TCP throughput using cwind and RTT. Here, cwind is the accumulated value of the packet length (Len) 112c from FirstDataID (1) to LastDataID (3) through Equation (10), that is, 3750. RTT is the accumulated value of RTTsry and RTTrcv through Equation (11), that is, 900. Therefore, the packet analysis device 1 calculates TP_{tcp} as 33.3 through Equation (1). Furthermore, the packet analysis device 1 changes the Status 111a of the analysis information table 111 into “VERIFY1”.

Subsequently, in a case in which the packet analysis device 1 consecutively receives DATA d14 and d15 of a subsequent group of the measurement group, the packet analysis device 1 stores information of the DATA d14 and information of the DATA d15 in the DATA table 112, respectively. Here, with regard to the DATA d14, “4” is stored as the data ID 112a, “1250” is stored as the Len (packet length) 112c, “3750” is stored as the Seq (Seq number) 112b, and “1400” is stored as the arrival time 112d. With regard to the DATA d15, “5” is stored as the data ID 112a, “1250” is stored as the Len (packet length) 112c, “5000” is stored as the Seq (Seq number) 112b, and “1500” is stored as the arrival time 112d.

Subsequently, in a case in which the packet analysis device 1 receives ACKa12, the packet analysis device 1 stores information of ACKa12 in the ACK table 113. Here, “2” is stored as the AckID 113a, “3750” is stored as the Ack (Ack number) 113b, and “2800” is stored as the AckTime (arrival time) 113c. Furthermore, the packet analysis device 1 associates the received ACKa12 with the DATA. Here, the Ack (Ack number) 113b of ACKa12 is 3750. In a case in which the data ID 112a of the DATA table 112 is “3”, the Seq number (Seq) 112b is 2500 and the packet length (Len) 112c is 1250. Therefore, since the packet analysis device 1 satisfies the condition of Equation (12), “3”, which is stored as the data ID 112a, is stored in the data ID 113d of the ACK table 113.

Furthermore, since the Status 111a is “VERIFY1” and the received ACKa11 corresponds to the final DATA of the measurement group, the packet analysis device 1 measures the approximate value TP_{rcv1} of the network band. Here, the amount of data (Sizercv1) of DATA, acquired by excluding the initial DATA d11 from the measurement group, is the difference between the Ack number of LastAckID (2) and the Ack number of FirstAckID (1) through Equation (15), that is, 2500. ACK interval (TimeGaprcv1) is the difference between the arrival time of LastAckID (2) and the arrival time of FirstAckID (1) through Equation (16), that is, 1000. Therefore, the packet analysis device 1 calculates TP_{rcv1} as 20 using Equation (17).

Furthermore, packet analysis device 1 determines whether or not TP_{tcp} is smaller than TP_{rcv1} in order to determine the validity of TP_{tcp}. Here, since TP_{tcp} is 33.3 and TP_{rcv1} is 20, TP_{tcp} is not smaller than TP_{rcv1}. Therefore, the packet analysis device 1 determines that TP_{tcp} is not valid. Here, the packet analysis device 1 changes the Status 111a of the analysis information table 111 into “VERIFY2”.

Subsequently, in a case in which the packet analysis device 1 receives ACKa13, the packet analysis device 1 stores information of ACKa13 in the ACK table 113. Here, “3” is stored as the AckID 113a, “6250” is stored as the Ack (Ack number) 113b, and “3800” is stored as the AckTime (arrival time) 113c. Furthermore, the packet analysis device 1 associates the received ACKa12 with DATA. Here, the Ack (Ack number) 113b of ACKa13 is 6250. In a case in which the data ID 112a of the DATA table 112 is “5”, the Seq number (Seq) 112b is 5000 and the packet length (Len) 112c is 1250. Therefore, since the packet analysis device 1 satisfies the condition of Equation (12), “5”, which is stored as the data ID 112a, is recorded in the data ID 113d of ACK table 113.

Furthermore, since Status 111a is “VERIFY2”, the packet analysis device 1 measures the throughput TPrcv2 for confirmation. Here, the amount of data of DATA of the subsequent group (Sizercv2) is the difference between the Ack number of LastAckID (2+1) and the Ack number of FirstAckID (1) through Equation (18), that is, 5000. The second ACK interval (TimeGaprcv2) is the difference between the arrival time of LastAckID (2+1) and the arrival time of FirstAckID (1) through Equation (19), that is, 2000. Therefore, the packet analysis device 1 calculates TP_{rcv2} as 20 using Equation (20).

Furthermore, the packet analysis device 1 determines whether or not TP_{tcp} is larger than TP_{rcv2} in order to determine the validity of TP_{rcv1}. Here, since TP_{tcp} is 33.3 and TP_{rcv2} is 20, TP_{tcp} is larger than TP_{rcv2}. Therefore, the packet analysis device 1 determines that TP_{rcv1} is valid. Here, the packet analysis device 1 determines the estimated value of the TCP throughput TP_{rcv1} as the effective throughput. Furthermore, the packet analysis device 1 records Sizercv1 (2500) as the measured byte number 114a and records TimeGaprcv1 (1000) as the measured time interval 114b in the statistical information table 114. That is, the case corresponds to a case in which a low throughput is measured in the low-speed section, with the result that there is a high possibility that the approximate value TP_{rcv1} of the network band is proper as the throughput of the of low-speed section, and thus the approximate value TP_{rcv1} of the network band is specified as the effective throughput.

[Output Example]

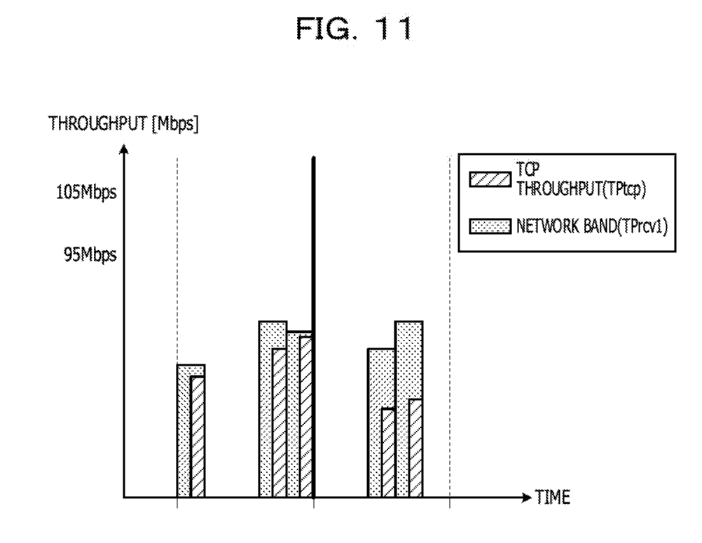

Subsequently, FIG. 11 is a diagram illustrating an output example. A graph illustrated in FIG. 11 is a graph which includes an X axis indicative of time and a Y axis indicative of a throughput [Mbps]. In the graph, the estimated value (TP_{tcp}) of the TCP throughput and the approximate value (TP_{rcv1}) of the network band, which are measured with the lapse of time, of each period are associated with each other and then output. In the output example, the estimated value (TP_{tcp}) of the TCP throughput in each period is smaller than the approximate value (TP_{rcv1}) of the network band, the effective throughput is specified as TP_{tcp}. Meanwhile, a color classification and a line division may be performed such that a value which is specified as the effective throughput is emphasized.

### Advantage of Embodiment

According to the embodiment, the packet analysis device 1 acquires packets, which are communicated between the terminal 3 and the terminal 4, at any spot of a network between the terminal 3 and the terminal 4. Furthermore, the packet analysis device 1 stores the acquired packets and acquisition time through association. Furthermore, the packet analysis device 1 calculates the first throughput value based on time, which is taken from acquisition of the first data which is the initial DATA corresponding to a predetermined group transmitted from the terminal 4 and acquisition of the first ACK corresponding to the first DATA transmitted from the terminal 3, and the amount of first packet, which is the amount of DATA of the group. The packet analysis device 1 calculates the second throughput value based on time, which is taken from acquisition of the first ACK to the acquisition of the second ACK that is the final ACK, and the amount of second packet which is the amount of DATA acquired by excluding the first DATA from the group. Furthermore, the packet analysis device 1 compares the first throughput value with the second throughput value, and specifies the throughput value of a predetermined section corresponding to the group. According to the configuration, it is possible for the packet analysis device 1 to further accurately calculate the throughput value of the low-speed section using the first throughput value and the second throughput value.

In addition, according to the embodiment, the packet analysis device 1 further calculates a third throughput value based on time, which is taken from acquisition of the first ACK to acquisition of a third ACK that is ACK of a subsequent group transmitted from the terminal 4 according to the acquisition of the first ACK, and the amount of second packet and the amount of DATA of the subsequent group. Furthermore, the packet analysis device 1 compares the first throughput value and the third throughput value, and specifies any one of the first throughput value and the second throughput value as the throughput value of a predetermined section according to the result of comparison. According to the configuration, it is possible for the packet analysis device 1 to accurately estimate the throughput in the group using the third throughput value which includes ACK of the subsequent group other than the group.

In addition, according to the embodiment, the packet analysis device 1 outputs a graph illustrating the transition of a throughput value in a predetermined section using information including the throughput value which is specified for each period. According to the configuration, it is possible for the packet analysis device 1 to visualize the throughput value which changes for each period.

### The Others

Meanwhile, it is possible to realize the packet analysis device 1 by mounting the respective functions of the connection management unit 123 and the throughput estimation unit 124 on an information processing device, such as a well-known personal computer and a workstation.

In addition, each of the components of the device illustrated in the drawing may not be physically configured as illustrated in the drawing. That is, the detailed aspect of the division or the integration of a device is not limited to the device illustrated drawing, and it is possible to configure all or a part of the components through functional or physical division or integration according to various loads, usages, or the like in an arbitrary unit. For example, the input interface 122 and the connection management unit 123 may be integrated as one unit. In contrast, the throughput estimation unit 124 may be divided into a first determination unit that determines the validity of the estimated value of the TCP throughput, a second determination unit that determines the validity of the approximate value the network band, and an estimation unit that estimates the throughput. In addition, the analysis information table 111, the DATA table 112, the ACK table 113, and the statistical information table 114 may be coupled as the external device of the packet analysis device 1 through a network.

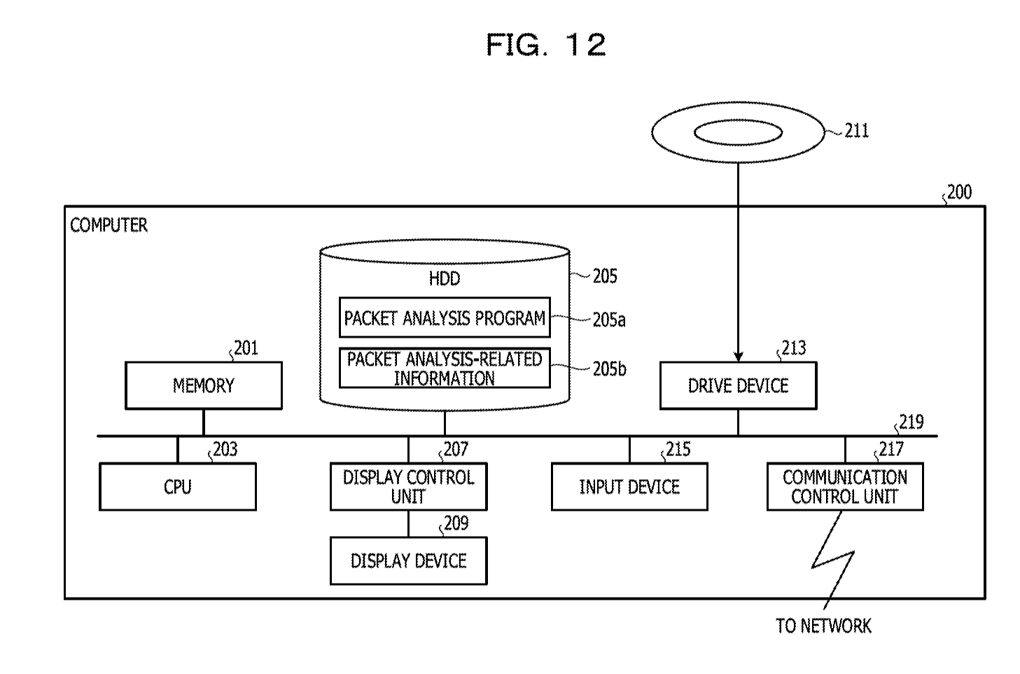

In addition, it is possible to realize the various processes which are described in the embodiment by executing a prepared program in a computer, such as a personal computer or a workstation. Here, hereinafter, an example of a computer which executes a packet analysis program that realizes the same function as that of the packet analysis device 1 illustrated in FIG. 1 will be described. FIG. 12 is a view illustrating an example of the computer which executes the packet analysis program.

As illustrated in FIG. 12, the computer 200 includes a CPU 203 which executes various operation processes, an input device 215 which receives data input from a user, and a display control unit 207 which controls the display device 209. In addition, the computer 200 includes a drive device 213 which reads a program from a storage medium, and a communication control unit 217 which exchanges data between other computers through a network. In addition, the computer 200 includes a memory 201 which temporally stores various pieces of information, and an HDD 205. Further, the memory 201, the CPU 203, the HDD 205, the display control unit 207, the drive device 213, the input device 215, and the communication control unit 217 are coupled to each other through a bus 219.

The drive device 213 is, for example, a device for a removal disk 211. The HDD 205 stores a packet analysis program 205a and packet analysis-related information 205b.

The CPU 203 reads the packet analysis program 205a, deploys the packet analysis program 205a in the memory 201, and executes the packet analysis program 205a as a process. The process corresponds to each of the functional units of the packet analysis device 1. The packet analysis-related information 205b corresponds to the analysis information table 111, the DATA table 112, the ACK table 113, and the statistical information table 114. Further, for example, the removal disk 211 stores each piece of information such as the packet analysis program 205a.

Meanwhile, the packet analysis program 205a may not be stored in the HDD 205 from the beginning. For example, the program is stored in a “portable physical medium”, such as a flexible disk (FD), a CD-ROM, a DVD disk, a magneto-optic disk, or an IC card, which is inserted into the computer 200. Further, the computer 200 may read the packet analysis program 205a from among them and execute the packet analysis program 205a.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A device comprising:
a memory; and
a processor coupled to the memory and configured to:
specify a first time difference between a first time in which a first data packet is transmitted by a transmitter toward a receiver and a second time in which a first response packet corresponding to the first data packet is received by the transmitter,
specify a second time difference between the second time and a third time in which a second response packet is received by the transmitter, the second response packet being a final response packet corresponding to one or more second data packets transmitted by the transmitter toward the receiver after the first time and before the second time,
specify a first data amount which is a total data amount of the one or more second data packets, and a second data amount which is a total data amount of the first data packet and the one or more second data packets,
specify a first throughput value based on the second data amount and the first time difference,
specify a second throughput value based on the first data amount and the second time difference, and
output the first throughput value when the first throughput value is equal to or smaller than the second throughput value.

2. The device according to claim 1, wherein
the processor is further configured to:
specify a third time interval between the second time and a fourth time in which a third response packet is received by the transmitter, the third response packet being a final response packet corresponding to one or more third data packets transmitted by the transmitter toward the receiver after the second time,
specify a third data amount which is the total data amount of the one or more third data packets,
specify a third throughput value based on a total value of the second data amount and the third data amount, and the third time interval, and
output the first throughput value when the first throughput value is equal to or smaller than the third throughput value.

3. The device according to claim 2, wherein
the one or more third data packets are transmitted by the transmitter before the third response packet is received by the transmitter.

4. The device according to claim 1, wherein
the device is provided at any spot of a network which couples the transmitter and the receiver.

5. The device according to claim 1, wherein
the processor is configured to:
specify the first throughput value by dividing the second data amount by the first time difference, and
specify the second throughput value by dividing the first data amount by the second time difference.

6. The device according to claim 2, wherein
the processor is configured to specify the third throughput value by dividing the total value of the second data amount and the third data amount by the third time interval.

7. A communication system comprising:
a transmitter;
a receiver; and
an analyzing device including a memory and a processor coupled to the memory, the processor being configured to:
specify a first time difference between a first time in which a first data packet is transmitted by the transmitter toward the receiver and a second time in which a first response packet corresponding to the first data packet is received by the transmitter,
specify a second time difference between the second time and a third time in which a second response packet is received by the transmitter, the second response packet being a final response packet corresponding to the one or more second data packets transmitted by the transmitter toward the receiver after the first time and before the second time,
specify a first data amount which is a total data amount of the one or more second data packets, and a second data amount which is a total data amount of first data packet and the one or more second data packets,
specify a first throughput value based on the second data amount and the first time difference,
specify a second throughput value based on the first data amount and the second time difference, and
output the first throughput value when the first throughput value is equal to or smaller than the second throughput value.

8. The communication system according to claim 7, wherein
the processor is further configured to:
specify a third time interval between the second time and a fourth time in which a third response packet is received by the transmitter, the third response packet being a final response packet corresponding to one or more third data packets transmitted by the transmitter toward the receiver after the second time,
specify a third data amount which is the total data amount of the one or more third data packets,
specify a third throughput value based on a total value of the second data amount and the third data amount, and the third time interval, and
output the first throughput value when the first throughput value is equal to or smaller than the third throughput value.

9. The communication system according to claim 8, wherein
the one or more third data packets are transmitted by the transmitter before the third response packet is received by the transmitter.

10. The communication system according to claim 7, wherein
the analyzing device is provided at any spot of a network which couples the transmitter and the receiver.

11. The communication system according to claim 7, wherein
the processor is configured to:
specify the first throughput value by dividing the second data amount by the first time difference, and
specify the second throughput value by dividing the first data amount by the second time difference.

12. The communication system according to claim 8, wherein
the processor is configured to specify the third throughput value by dividing the total value of the second data amount and the third data amount by the third time interval.

13. A method using a communication system including a transmitter, a receiver and an analyzing device, the method comprising:
specifying, by the analyzing device, a first time difference between a first time in which a first data packet is transmitted by the transmitter toward the receiver and a second time in which a first response packet corresponding to the first data packet is received by the transmitter;
specifying, by the analyzing device, a second time difference between the second time and a third time in which a second response packet is received by the transmitter, the second response packet being a final response packet corresponding to the one or more second data packets transmitted by the transmitter toward the receiver after the first time and before the second time;
specifying, by the analyzing device, a first data amount which is a total data amount of the one or more second data packets, and a second data amount which is a total data amount of first data packet and the one or more second data packets;
specifying, by the analyzing device, a first throughput value based on the second data amount and the first time difference;
specifying, by the analyzing device, a second throughput value based on the first data amount and the second time difference; and
outputting, by the analyzing device, the first throughput value when the first throughput value is equal to or smaller than the second throughput value.

14. The method according to claim 13, further comprising:
specifying, by the analyzing device, a third time interval between the second time and a fourth time in which a third response packet is received by the transmitter, the third response packet being a final response packet corresponding to one or more third data packets transmitted by the transmitter toward the receiver after the second time;
specifying, by the analyzing device, a third data amount which is the total data amount of the one or more third data packets;
specifying, by the analyzing device, a third throughput value based on a total value of the second data amount and the third data amount, and the third time interval; and
outputting, by the analyzing device, the first throughput value when the first throughput value is equal to or smaller than the third throughput value.

15. The method according to claim 14, further comprising:
transmitting, by the transmitter, the one or more third data packets before the third response packet is received by the transmitter.

16. The method according to claim 13, wherein
the analyzing device is provided at any spot of a network which couples the transmitter and the receiver.

17. The method according to claim 13, further comprising:
specifying, by the analyzing device, the first throughput value by dividing the second data amount by the first time difference; and
specifying, by the analyzing device, the second throughput value by dividing the first data amount by the second time difference.

18. The method according to claim 14, further comprising:
specifying, by the analyzing device, the third throughput value by dividing the total value of the second data amount and the third data amount by the third time interval.
